(19) United States
(12) Patent Application Publication
(10) Pub. No.: US 2007/0032918 A1
(43) Pub. Date: Feb. 8, 2007

(54) Automobile safety device and method of using the same

(76) Inventor: Yen-Ji Chang, Tsao Tuen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/368,487

(22) Filed: Mar. 7, 2006

(30) Foreign Application Priority Data
Aug. 3, 2005 (TW) 94126380
Oct. 18, 2005 (TW) 94136407

(51) Int. Cl. G05D 99/00

(52) U.S. Cl. 701/2

(57) ABSTRACT

An automobile safety device and a method of using the same are disclosed. The automobile safety device can offer essential urgent treatment automatically (such as utilizing a wireless communication unit in an automobile to notify an automobile owner to come to the location of the automobile, utilizing a burglarproof system of the automobile in order to bring the passerby's attention, turning on an air supply/heat dissipation unit in the automobile or rolling down the windows of the automobile automatically in order to dissipate the heat and supply air) in a situation that people are stranded in the car, by detecting the internal state of the automobile automatically. Hence, the present invention can prevent or reduce the danger that people (especially infant and pre-school children) are stranded in the automobile, such as causing stuffy extremely people's accident due to overheat or lack of oxygen.

### BACKGROUND OF THE INVENTION

1. Field of The Invention

The present invention relates to an automobile safety device and a method of using the same, and particularly relates to drawing attention to an urgent situation in which people are stranded in an automobile. This is achieved by automatically detecting the internal state of the automobile, and taking steps to reduce the danger of the situation in which people (especially infants) are stranded in an automobile.

2. Description of the Related Art

Unless covered or shaded, automobiles are consistently exposed to the heat of the sun's rays. This causes the temperature inside the automobile to rise. As the interior of most automobiles is an airtight compartment, oxygen cannot enter the environment. Therefore, any people inside the automobile have only a limited supply of oxygen. Furthermore, as the temperature rises, the people will consume greater and greater amounts of oxygen as their level of distress become greater. As such, it is easy to shift from a situation in which a stuffy environment makes people feel uncomfortable, to one in which a tragedy ensues.

For solving the above-mentioned problem, a fan that turns on automatically when the temperature in the automobile rises to a certain point is disclosed. Thereby, heat is dissipated from the airtight compartment of the automobile. However, in order to guarantee an available power supply sufficient enough to allow the automobile to be turned on when the driver returns, when the power level of the automobile's battery drops below a certain level, the fan shuts off. If someone is stranded in the automobile for a long time, and the heat dissipation function is turned off, using the above-mentioned technology may still allow a tragedy to take place.

### SUMMARY OF THE INVENTION

The present invention provides an automobile safety device and a method of using the same. The present invention can offer essential urgent treatment automatically (such as utilizing a wireless communication device in the automobile to notify the automobile owner to come to the location of the automobile, utilizing a burglarproof system of the automobile in order to bring the passerby's attention, turning on the air supply/heat dissipation device in the automobile or rolling down the windows of the automobile automatically in order to dissipate the heat and supply air) in a situation that people are stranded in the car, by detecting the internal state (for example, the temperature is too high, the oxygen content is too low, etc.) of the automobile automatically. Hence, the present invention can prevent or reduce the danger that people (especially infant and pre-school children) are stranded in the automobile, such as causing stuffy extremely people's accident due to overheat or lack of oxygen.

A first aspect of the present invention is an automobile safety device. The automobile safety device comprises a center control unit, an automobile state sensing unit, a life sign sensing unit, a life demand value sensing unit, an air supply/heat dissipation unit and a wireless communication unit.

The automobile state sensing unit is connected electrically with the center control unit for sensing a state of an automobile. The life sign sensing unit is connected electrically with the center control unit for determining whether to sense whether there is any sign of life in the automobile, according to the state of the automobile. The life demand value sensing unit is connected electrically with the center control unit for determining whether to sense whether life demand value does not conform to a predetermined standard value, according as the life sign sensing unit senses whether there is any sign of life or not in the automobile.

Moreover, the state of the automobile is that a total stoppage time during a stoppage state of the automobile whether to reach a predetermined stoppage time of the automobile state sensing unit, wherein the stoppage state of the automobile is that an engine of the automobile is shut or an odometer of the automobile is stopped.

Furthermore, the state of the automobile is that a central locking system of the automobile whether to be turned on to lock car doors of the automobile, wherein the life sign sensing unit determines whether to sense whether there is any sign of life in the automobile, according as the central locking system of the automobile whether to be turned on to lock car doors of the automobile.

In addition, the air supply/heat dissipation unit is connected electrically with the center control unit for determining whether to turn on the air supply/heat dissipation unit, according as life demand value sensing unit senses whether life demand value does not conform to the predetermined standard value. The wireless communication unit is connected electrically with the center control unit for determining whether to transmit out a predetermined signal to notify predetermined correlative persons to come to a location of the automobile.

Moreover, the first aspect of the present invention further comprises a first timer unit connected electrically with the center control unit, and the first timer unit and the air supply/heat dissipation unit are turned on at the same time, wherein when a total turn-on time of the air supply/heat dissipation unit reaches a first predetermined time of the first timer unit, a burglarproof system of the automobile is turned off and an engine of the automobile is turned on for supplying power to a battery of automobile.

Furthermore, the first aspect of the present invention further comprises a second timer unit connected electrically with the center control unit, and the second timer unit and the wireless communication unit are turned on at the same time, wherein when a second predetermined time of the second timer unit is up, a burglarproof system of the automobile is turned on and sends out SOS signals.

In addition, the first aspect of the present invention further comprises a third timer unit connected electrically with the center control unit, and the third timer unit and a burglarproof system of the automobile are turned on at the same time, wherein when a total turn-on time of the burglarproof system reaches a third predetermined time of the third timer unit, the burglarproof system is turned off.

Moreover, the first aspect of the present invention further comprises an oil quantity sensing unit connected electrically with the center control unit, wherein when oil in an oil box of the automobile are less than a predetermined value, windows of the automobile are rolled down via a window control device of the automobile.

A second aspect of the present invention is a method of using an automobile safety device. The method comprises: firstly, turning on an automobile state sensing unit connected electrically with a center control unit for sensing a state of an automobile; next, turning on a life sign sensing unit connected electrically with the center control unit for sensing that whether there is any sign of life in the automobile, according to the state of the automobile.

Moreover, the method further comprises: if sensing that there are signs of life in the automobile, turning on a life demand value sensing unit connected electrically with the center control unit for sensing that whether life demand value does not conform to a predetermined standard value in the automobile;

Furthermore, the method further comprises: if the life demand value does not conform to the predetermined standard value, turning on both an air supply/heat dissipation unit and a wireless communication unit at the same time, wherein both the air supply/heat dissipation unit and the wireless communication unit are connected electrically with the center control unit, the air supply/heat dissipation unit is used to supply external air into the automobile and dissipate heat from the automobile, and the wireless communication unit is used to transmit out a predetermined signal to notify predetermined correlative persons to come to a location of the automobile.

Moreover, the state of the automobile is that a total stoppage time during a stoppage state of the automobile whether to reach a predetermined stoppage time of the automobile state sensing unit, wherein the stoppage state of the automobile is that an engine of the automobile is shut or an odometer of the automobile is stopped.

Furthermore, the state of the automobile is that a central locking system of the automobile whether to be turned on to lock car doors of the automobile, wherein the life sign sensing unit determines whether to sense whether there is any sign of life in the automobile, according as the central locking system of the automobile whether to be turned on to lock car doors of the automobile.

In addition, the air supply/heat dissipation unit is connected electrically with the center control unit for determining whether to turn on the air supply/heat dissipation unit, according as life demand value sensing unit senses whether life demand value does not conform to the predetermined standard value. The wireless communication unit is connected electrically with the center control unit for determining whether to transmit out a predetermined signal to notify predetermined correlative persons to come to a location of the automobile.

Moreover, the second aspect of the present invention further comprises a first timer unit connected electrically with the center control unit, and the first timer unit and the air supply/heat dissipation unit are turned on at the same time, wherein when a total turn-on time of the air supply/heat dissipation unit reaches a first predetermined time of the first timer unit, a burglarproof system of the automobile is turned off and an engine of the automobile is turned on for supplying power to a battery of automobile.

Furthermore, the second aspect of the present invention further comprises a second timer unit connected electrically with the center control unit, and the second timer unit and the wireless communication unit are turned on at the same time, wherein when a second predetermined time of the second timer unit is up, a burglarproof system of the automobile is turned on and sends out SOS signals.

In addition, the second aspect of the present invention further comprises a third timer unit connected electrically with the center control unit, and the third timer unit and a burglarproof system of the automobile are turned on at the same time, wherein when a total turn-on time of the burglarproof system reaches a third predetermined time of the third timer unit, the burglarproof system is turned off.

Moreover, the second aspect of the present invention further comprises an oil quantity sensing unit connected electrically with the center control unit, wherein when oil in an oil box of the automobile are less than a predetermined value, windows of the automobile are rolled down via a window control device of the automobile. In addition, after the step of automatically rolling down the windows, further comprises turning off an engine of the automobile.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block diagram of an automobile safety device according as the present invention;

FIGS. 2 and 2A are a flowchart of a method of using an automobile safety device according to the first embodiment of the present invention; and

FIG. 3 is a flowchart of a method of using an automobile safety device according to the second embodiment of the present invention.

### DETAILED DESCRIPTION OF PREFERRED BEST MOLDS

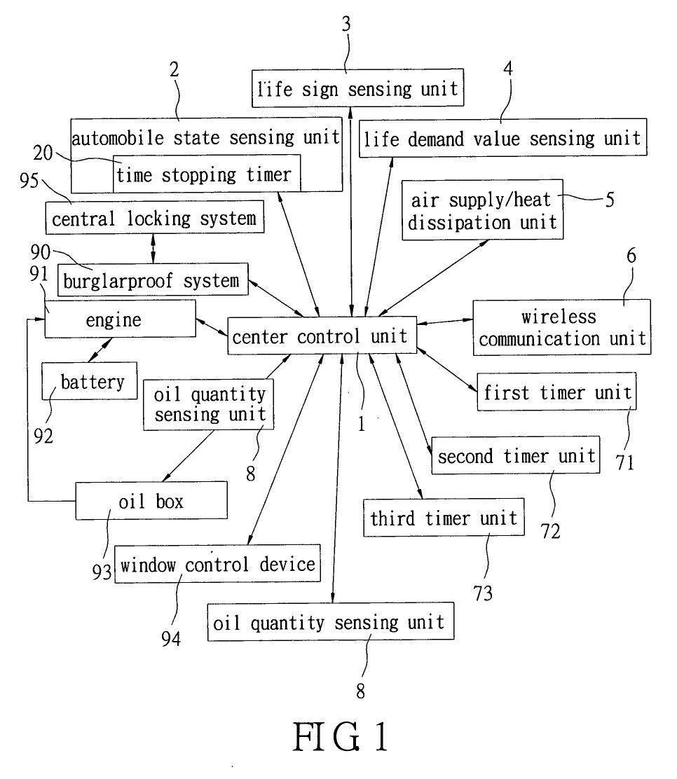

FIG. 1 shows a function block diagram of an automobile safety device according as the present invention. The present invention provides an automobile safety device, including a center control unit 1, an automobile state sensing unit 2, a life sign sensing unit 3, a life demand value sensing unit 4, an air supply/heat dissipation unit 5 and a wireless communication unit 6.

The automobile state sensing unit 2 is connected electrically with the center control unit 1 for sensing a state of an automobile. The life sign sensing unit 3 is connected electrically with the center control unit 1 for determining whether to sense whether there is any sign of life in the automobile, according to the state of the automobile. The life sign sensing unit 3 can be an infrared sensor. Moreover, the state of the automobile is that a total stoppage time during a stoppage state of the automobile whether to reach a predetermined stoppage time of the automobile state sensing unit 2. Hence, the life sign sensing unit 3 is able to determine whether to sense whether there is any sign of life in the automobile, according as the total stoppage time during the stoppage state of the automobile whether to reach the predetermined stoppage time of the automobile state sensing unit 2. The stoppage state of the automobile is that an engine of the automobile is shut or an odometer of the automobile is stopped.

For example, suppose the stoppage time of the automobile state sensing unit 2 is one minute. When the odometer of the automobile does not move, turning on a time stopping timer 20 of the automobile state sensing unit 2 for calculating the total stoppage time during the stoppage state (the odometer is stopped) of the automobile. If the total stoppage time during the stoppage state (the odometer is stopped) of the automobile reaches one minute, turning on the life sign sensing unit 3 for sensing that whether there is any sign of life in the automobile. Otherwise, when the engine of the automobile is shut, turning on the time stopping timer 20 for calculating the total stoppage time during the stoppage state (the engine is shut) of the automobile. If the total stoppage time during the stoppage state (the engine is shut) of the automobile reaches one minute, turning on the life sign sensing unit 3 for sensing that whether there is any sign of life in the automobile. Moreover, when the engine of the automobile is shut, the life sign sensing unit 3 also can be directly turned on the life sign sensing unit 3 for sensing that whether there is any sign of life in the automobile without turning on the time stopping timer 20.

Furthermore, the life demand value sensing unit 4 is connected electrically with the center control unit 1 for determining whether to sense whether life demand value does not conform to a predetermined standard value, according as the life sign sensing unit senses whether there is any sign of life or not in the automobile 3. The life demand value sensing unit 4 can be an oxygen content/temperature sensor for sensing oxygen content and temperature, and the life demand value sensing unit 4 has a predetermined upper/lower limit value of oxygen content and temperature.

In addition, the air supply/heat dissipation unit 5 is connected electrically with the center control unit 1 for determining whether to turn on the air supply/heat dissipation unit 5, according as life demand value sensing unit 4 senses whether life demand value does not conform to the predetermined standard value. The air supply/heat dissipation unit 5 can be a heat-dissipating fan for guiding external air into the automobile to supply fresh air and dissipate heat from the automobile.

Moreover, the wireless communication unit 6 is connected electrically with the center control unit 1 for determining whether to transmit out a predetermined signal to notify predetermined correlative persons (for example an automobile owner or family members of the automobile owner) to come to a location of the automobile. The wireless communication unit 6 can be a satellite communication device or a SIM (Simple Instant Messenger) card communication device, and the predetermined signal can be a voice phone call or a message. In other words, the wireless communication unit 6 can dial a phone call or transmit a message to the predetermined correlative persons.

Furthermore, the present invention further includes a first timer unit 71 connected electrically with the center control unit 1, and the first timer unit 71 and the air supply/heat dissipation unit 5 are turned on at the same time, wherein when a total turn-on time of the air supply/heat dissipation unit 5 reaches a first predetermined time of the first timer unit 71, a burglarproof system 90 of the automobile is turned off and an engine 91 of the automobile is turned on for supplying power to a battery 92 of automobile.

In addition, the present invention further includes a second timer unit 72 connected electrically with the center control unit 1, and the second timer unit 72 and the wireless communication unit 6 are turned on at the same time, wherein when a second predetermined time of the second timer unit 72 is up, the burglarproof system 90 of the automobile is turned on and sends out SOS signals to give the alarm to passerby.

Moreover, the present invention further includes a third timer unit 73 connected electrically with the center control unit 1, and the third timer unit 73 and the burglarproof system 90 of the automobile are turned on at the same time, wherein when a total turn-on time of the burglarproof system 90 reaches a third predetermined time of the third timer unit 73, the burglarproof system 90 is turned off.

Furthermore, the present invention further includes comprising an oil quantity sensing unit 8 connected electrically with the center control unit 1, wherein when oil in an oil box 93 of the automobile are less than a predetermined value, windows of the automobile are rolled down via a window control device 94 of the automobile. At the same time, the engine 91 is turned off to save oil for that when the automobile owner comes to the location of the automobile, the automobile has enough oil to be turned on again by the automobile owner.

In addition, the state of the automobile is that whether a central locking system 95 of the automobile is turned on to lock car doors of the automobile. Hence the life sign sensing unit 3 can determine whether to sense whether there is any sign of life in the automobile, according as the central locking system 95 of the automobile whether to be turned on to lock car doors of the automobile. In other words, when the central locking system 95 is turned on, the burglarproof system 90 connected electrically to the central locking system 95 is turned on, too. Moreover, when the automobile state sensing unit 2 senses that the central locking system 95 is turned on to lock the car doors, the life sign sensing unit 3 is turned on automatically to sense whether there is any sign of life in the automobile.

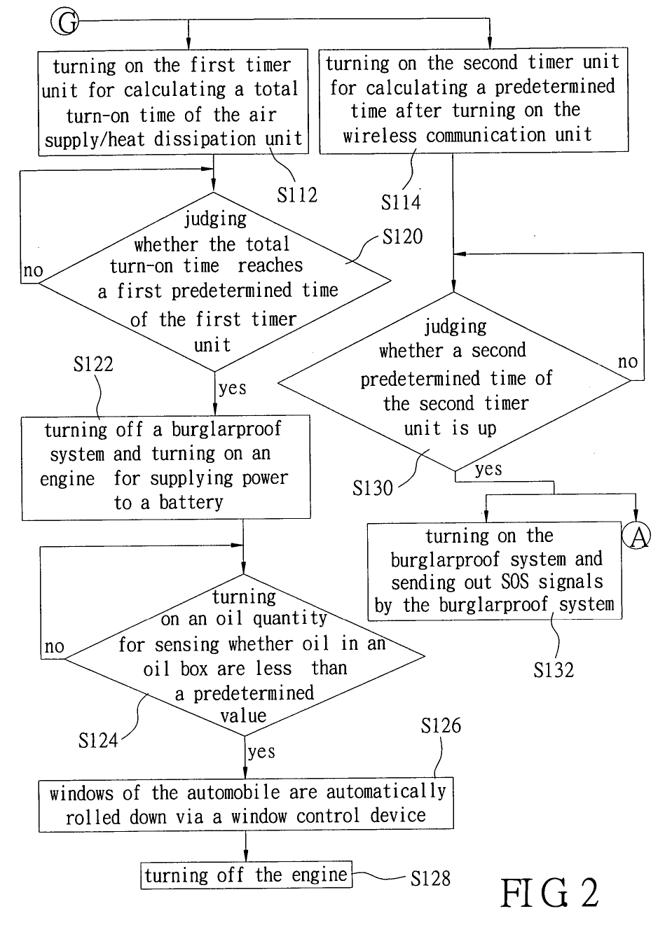

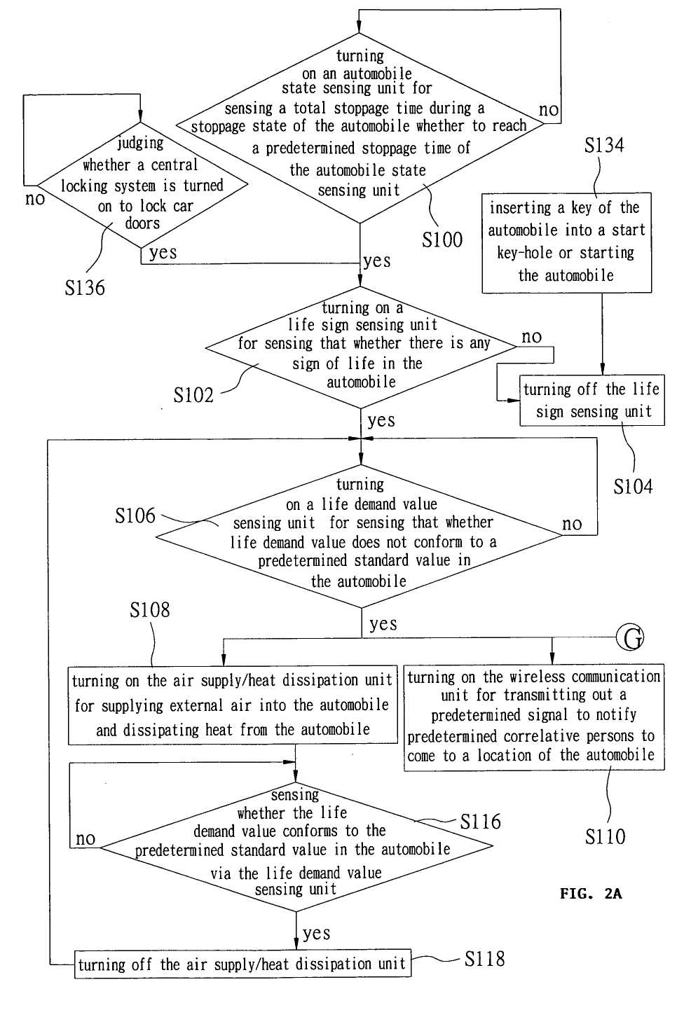

FIG. 2 shows a flowchart of a method of using an automobile safety device according as the first embodiment of the present invention. The present invention provides a method of using an automobile safety device. The method comprises: firstly, turning on an automobile state sensing unit 2 connected electrically with a center control unit 1 for sensing a total stoppage time during a stoppage state of the automobile whether to reach a predetermined stoppage time of the automobile state sensing unit 2 (S100), and the stoppage state of the automobile is that an engine 91 of the automobile is shut or an odometer of the automobile is stopped. If the step of S100 is no, continuously executing the step S100. If the step of S100 is yes, turning on a life sign sensing unit 3 connected electrically with the center control unit 1 for sensing that whether there is any sign of life in the automobile during a predetermined sensing time (S102).

Moreover, if the step of S102 is no, turning off the life sign sensing unit 3. If the step of S102 is yes, turning on a life demand value sensing unit 4 connected electrically with the center control unit 1 for sensing that whether life demand value does not conform to a predetermined standard value in the automobile (S106). If the step of S106 is yes (the life demand value does not conform to the predetermined standard value), turning on all an air supply/heat dissipation unit 5, a wireless communication unit 6, a first timer unit 71 and a second timer unit 72 at the same time. Moreover all the air supply/heat dissipation unit 5, the wireless communication unit 6, the first timer unit 71 and the second timer unit 72 are connected electrically with the center control unit 1. The air supply/heat dissipation unit 5 is used to supply external air into the automobile and dissipate heat from the automobile (S108), and the wireless communication unit 6 is used to transmit out a predetermined signal to notify predetermined correlative persons to come to a location of the automobile (S110). The first timer unit 71 is used to calculate a total turn-on time of the air supply/heat dissipation unit 5 (S112). The second timer unit 72 is used to calculate a predetermined time after turning on the wireless communication unit 6 (S114).

Furthermore, after the step of S108, the method further comprises sensing whether the life demand value conforms to the predetermined standard value in the automobile via the life demand value sensing unit 4 (S116). If the step of S116 is no, continuously executing the step of S1116. If the step of S116 is yes, turning off the air supply/heat dissipation unit 5 (S118).

In addition, after the step of S112, the method further comprises judging whether the total turn-on time of the air supply/heat dissipation unit 5 reaches a first predetermined time of the first timer unit 71 (S120). If the step of S120 is no, continuously executing the step of S120. If the step of S120 is yes, turning off a burglarproof system 90 of the automobile and turning on an engine 91 of the automobile for supplying power to a battery 92 of automobile (S122). Next, turning on an oil quantity sensing unit 8 that is connected electrically with the center control unit 1 for sensing whether oil in an oil box 93 of the automobile are less than a predetermined value (S124). If the step of S124 is no, continuously executing the step of S124. If the step of S124 is yes, windows of the automobile are automatically rolled down via a window control device 94 of the automobile (S126). After the step of S126, the method further comprising turning off the engine 91 (S128) to save oil for that when the automobile owner comes to the location of the automobile, the automobile has enough oil to be turned on again by the automobile owner.

Moreover, after the step of S114, the method further comprises judging whether a predetermined time after turning on the wireless communication unit 6 reaches a second predetermined time of the second timer unit 72 (S130). If the step of S130 is no, continuously executing the step of S130. If the step of S130 is yes, turning on the burglarproof system 90 of the automobile and sending out SOS signals by the burglarproof system 90 (S132) for giving the alarm to passerby.

Furthermore, the method further comprises inserting a key of the automobile into a start key-hole of the automobile or starting the automobile (S134) for executing the step of S104 (turning off the life sign sensing unit 3), and judging whether a central locking system 95 of the automobile is turned on to lock car doors of the automobile (S136) for determining whether to execute the step of S102. In addition, when the life demand value sensing unit 4 is turned on, executing the step of S104 for turning off the life sign sensing unit 3.

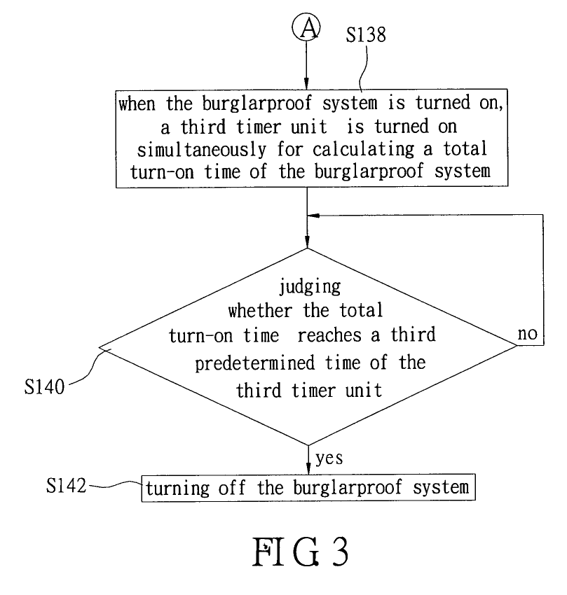

FIG. 3 shows a flowchart of a method of using an automobile safety device according as the second embodiment of the present invention. If the step of S130 is yes, the method further comprises: when the burglarproof system 90 is turned on, a third timer unit 73 connected electrically with the center control unit 1 is turned on simultaneously for calculating a total turn-on time of the burglarproof system 90 (S138). Next, the method further comprises judging whether the total turn-on time of the burglarproof system 90 reaches a third predetermined time of the third timer unit 73 (S140). If the step of S140 is no, continuously executing the step of S140. If the step of S140 is yes, turning off the burglarproof system 90 (S142).

In sum, the present invention can offer essential urgent treatment automatically (such as utilizing the wireless communication unit 6 in the automobile to notify the automobile owner to come to the location of the automobile, utilizing the burglarproof system 90 of the automobile in order to bring the passerby's attention, turning on the air supply/heat dissipation unit 5 in the automobile or rolling down the windows of the automobile automatically in order to dissipate the heat and supply air) in a situation that people are stranded in the car, by detecting the internal state (for example, the temperature is too high, the oxygen content is too low, etc.) of the automobile automatically. Hence, the present invention can prevent or reduce the danger that people (especially infant and pre-school children) are stranded in the automobile, such as causing stuffy extremely people's accident due to overheat or lack of oxygen.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An automobile safety device, comprising:
a center control unit;
an automobile state sensing unit connected electrically with the center control unit for sensing a state of an automobile;
a life sign sensing unit connected electrically with the center control unit for determining whether to sense whether there is any sign of life in the automobile, according to the state of the automobile;
a life demand value sensing unit connected electrically with the center control unit for determining whether to sense whether life demand value does not conform to a predetermined standard value, according as the life sign sensing unit senses whether there is any sign of life or not in the automobile;
an air supply/heat dissipation unit connected electrically with the center control unit for determining whether to turn on the air supply/heat dissipation unit, according as life demand value sensing unit senses whether life demand value does not conform to the predetermined standard value; and
a wireless communication unit connected electrically with the center control unit for determining whether to transmit out a predetermined signal to notify predetermined correlative persons to come to a location of the automobile.

2. The automobile safety device as claimed in claim 1, wherein the state of the automobile is that a total stoppage time during a stoppage state of the automobile whether to reach a predetermined stoppage time of the automobile state sensing unit; wherein the stoppage state of the automobile is that an engine of the automobile is shut or an odometer of the automobile is stopped.

3. The automobile safety device as claimed in claim 2, wherein the life sign sensing unit determines whether to sense whether there is any sign of life in the automobile, according as the total stoppage time during the stoppage state of the automobile whether to reach the predetermined stoppage time of the automobile state sensing unit, wherein the automobile state sensing unit has a time stopping timer for calculating the total stoppage time during the stoppage state of the automobile.

4. The automobile safety device as claimed in claim 1, wherein the state of the automobile is that a central locking system of the automobile whether to be turned on to lock car doors of the automobile, wherein the life sign sensing unit determines whether to sense whether there is any sign of life in the automobile, according as the central locking system of the automobile whether to be turned on to lock car doors of the automobile.

5. The automobile safety device as claimed in claim 1, further comprising a first timer unit connected electrically with the center control unit, and the first timer unit and the air supply/heat dissipation unit are turned on at the same time, wherein when a total turn-on time of the air supply/heat dissipation unit reaches a first predetermined time of the first timer unit, a burglarproof system of the automobile is turned off and an engine of the automobile is turned on for supplying power to a battery of automobile.

6. The automobile safety device as claimed in claim 1, further comprising a second timer unit connected electrically with the center control unit, and the second timer unit and the wireless communication unit are turned on at the same time, wherein when a second predetermined time of the second timer unit is up, a burglarproof system of the automobile is turned on and sends out SOS signals.

7. The automobile safety device as claimed in claim 1, further comprising a third timer unit connected electrically with the center control unit, and the third timer unit and a burglarproof system of the automobile are turned on at the same time, wherein when a total turn-on time of the burglarproof system reaches a third predetermined time of the third timer unit, the burglarproof system is turned off.

8. The automobile safety device as claimed in claim 1, wherein the life sign sensing unit is an infrared sensor;
wherein the life demand value sensing unit is an oxygen content/temperature sensor for sensing oxygen content and temperature, and the life demand value sensing unit has a predetermined upper/lower limit value of oxygen content and temperature;
wherein air supply/heat dissipation unit is a heat-dissipating fan for guiding external air into the automobile to supply fresh air and dissipate heat from the automobile.

9. The automobile safety device as claimed in claim 1, further comprising an oil quantity sensing unit connected electrically with the center control unit, wherein when oil in an oil box of the automobile are less than a predetermined value, windows of the automobile are rolled down via a window control device of the automobile.

10. A method of using an automobile safety device, comprising:
turning on an automobile state sensing unit connected electrically with a center control unit for sensing a state of an automobile;
turning on a life sign sensing unit connected electrically with the center control unit for sensing that whether there is any sign of life in the automobile, according to the state of the automobile;
if sensing that there are signs of life in the automobile, turning on a life demand value sensing unit connected electrically with the center control unit for sensing that whether life demand value does not conform to a predetermined standard value in the automobile;
if the life demand value does not conform to the predetermined standard value, turning on both an air supply/heat dissipation unit and a wireless communication unit at the same time, wherein both the air supply/heat dissipation unit and the wireless communication unit are connected electrically with the center control unit, the air supply/heat dissipation unit is used to supply external air into the automobile and dissipate heat from the automobile, and the wireless communication unit is used to transmit out a predetermined signal to notify predetermined correlative persons to come to a location of the automobile.

11. The method as claimed in claim 10, wherein the state of the automobile is that a total stoppage time during a stoppage state of the automobile whether to reach a predetermined stoppage time of the automobile state sensing unit, wherein the stoppage state of the automobile is that an engine of the automobile is shut or an odometer of the automobile is stopped.

12. The method as claimed in claim 11, wherein the life sign sensing unit determines whether to sense whether there is any sign of life in the automobile, according as the total stoppage time during the stoppage state of the automobile whether to reach the predetermined stoppage time of the automobile state sensing unit, wherein the automobile state sensing unit has a time stopping timer for calculating the total stoppage time during the stoppage state of the automobile.

13. The method as claimed in claim 10, wherein the state of the automobile is that a central locking system of the automobile whether to be turned on to lock car doors of the automobile, wherein the life sign sensing unit determines whether to sense whether there is any sign of life in the automobile, according as the central locking system of the automobile whether to be turned on to lock car doors of the automobile.

14. The method as claimed in claim 10, further comprising a first timer unit connected electrically with the center control unit, and the first timer unit and the air supply/heat dissipation unit are turned on at the same time, wherein when a total turn-on time of the air supply/heat dissipation unit reaches a first predetermined time of the first timer unit, a burglarproof system of the automobile is turned off and an engine of the automobile is turned on for supplying power to a battery of automobile.

15. The method as claimed in claim 10, further comprising a second timer unit connected electrically with the center control unit, and the second timer unit and the wireless communication unit are turned on at the same time, wherein when a second predetermined time of the second timer unit is up, a burglarproof system of the automobile is turned on and sends out SOS signals.

16. The method as claimed in claim 10, further comprising a third timer unit connected electrically with the center control unit, and the third timer unit and a burglarproof system of the automobile are turned on at the same time, wherein when a total turn-on time of the burglarproof system reaches a third predetermined time of the third timer unit, the burglarproof system is turned off.

17. The method as claimed in claim 10, wherein the life sign sensing unit is an infrared sensor;
wherein the life demand value sensing unit is an oxygen content/temperature sensor for sensing oxygen content and temperature, and the life demand value sensing unit has a predetermined upper/lower limit value of oxygen content and temperature;
wherein air supply/heat dissipation unit is a heat-dissipating fan for guiding external air into the automobile to supply fresh air and dissipate heat from the automobile.

18. The method as claimed in claim 10, further comprising an oil quantity sensing unit connected electrically with the center control unit, wherein when oil in an oil box of the automobile are less than a predetermined value, windows of the automobile are automatically rolled down via a window control device of the automobile.

19. The method as claimed in claim 18, wherein after the step of automatically rolling down the windows, further comprises turning off an engine of the automobile.

20. The method as claimed in claim 10, wherein if the life sign sensing unit can not sense any sign of life in the mobile during a predetermined sensing time, turning off the life sign sensing unit; when a key of the automobile is inserted into a start key-hole of the automobile or the automobile is started, turning off the life sign sensing unit; when the life demand value sensing unit is turned on, turning off the life sign sensing unit.

21. The method as claimed in claim 10, wherein after the step of turning on the air supply/heat dissipation unit, further comprises:
sensing whether the life demand value conforms to the predetermined standard value in the automobile via the life demand value sensing unit;
if the life demand value does not conform to the predetermined standard value, continuously sensing whether the life demand value conforms to the predetermined standard value; and
if the life demand value conforms to the predetermined standard value, turning off the air supply/heat dissipation unit.
